(19) United States
(12) Patent Application Publication
(10) Pub. No.: US 2025/0289732 A1
(43) Pub. Date: Sep. 18, 2025

(54) POSITIVE ELECTRODE ACTIVE MATERIAL, METHOD OF PREPARING SAME, AND ELECTROCHEMICAL DEVICE INCLUDING SAME

(71) Applicant: KOREA INSTITUTE OF ENERGY RESEARCH, Daejeon (KR)

(72) Inventors: Sun Hwa YEON, Sejong-si (KR); Kyoung Hee SHIN, Daejeon (KR); Chang Soo JIN, Sejong-si (KR); Dong Ha KIM, Daejeon (KR); Se Kook PARK, Daejeon (KR); Seung Hae HWANG, Daejeon (KR); Donghee GUEON, Daejeon (KR); Yeon Ji CHOI, Changwon-si (KR); Dae Seon HONG, Daejeon (KR)

(73) Assignee: KOREA INSTITUTE OF ENERGY RESEARCH, Daejeon (KR)

(21) Appl. No.: 19/079,119

(22) Filed: Mar. 13, 2025

(30) Foreign Application Priority Data
Mar. 18, 2024 (KR) 10-2024-0036939

(51) Int. Cl. C01G 53/44; H01M 4/505

(52) U.S. Cl. CPC C01G 53/44; H01M 4/505; C01P 2002/72; C01P 2006/40

(57) ABSTRACT

Proposed are a positive electrode active material, a method of preparing the same, and an electrochemical device including the same. Specifically, proposed are a positive electrode active material capable of improving the specific capacity of an electrochemical device through control over the cooling temperature, cooling time, and sintering temperature of a precursor to prepare the positive electrode active material, a method of preparing the same, and an electrochemical device including the same.

### BACKGROUND

### 1. Technical Field

The present disclosure claims the benefit of Korean Patent Application Publication No. 10-2024-0036939, filed in the Korean Intellectual Property Office on Mar. 18, 2024, which is hereby incorporated by reference in its entirety into the present disclosure. The present disclosure relates to a positive electrode active material, a method of preparing the same, and an electrochemical device including the same. Specifically, the present disclosure relates to a positive electrode active material capable of improving the specific capacity of an electrochemical device through control over the cooling temperature, cooling time, and sintering temperature of a precursor to prepare the positive electrode active material, to a method of preparing the same, and to an electrochemical device including the same.

### 2. Description of the Related Art

In lithium-ion batteries, positive electrode active materials play predominant roles in various cell performance characteristics, battery weight, stability, and battery life. The more lithium ions a battery contains, the higher the battery capacity. In addition, battery life is affected by the stability of the crystal structure of a positive electrode active material. Consumers are demanding advanced properties, including higher energy density, longer life, a faster charging rate, and the like, and technology continues to be developed and studied to meet such demands. With the demand for positive electrode materials suitable for use in terms of high capacity and long cycle performance, overlithiated oxide (OLO) with high energy density is attracting attention as a new material.

OLO has high energy density, so OLO-based batteries have high capacity and excellent energy storage ability. In addition, due to the advantages of relatively low production costs and chemical stability, active research is in progress. Professor John Goodenough of the University of Texas at Austin, a Nobel Laureate in Chemistry in 2019, developed lithium-rich layered oxide. Lithium-rich layered oxide, which is a composite of Li₂MnO₃ and lithium oxide (for example, LiNiₓCo_{y}Mn_{z}O₂), serves as a positive electrode material containing 1 or more moles of lithium and is attracting attention as a next-generation positive electrode material due to having a high discharge capacity of 200 mAh/g or more.

However, lithium-rich layered oxide has difficulties in terms of commercialization due to several drawbacks. First, lithium-rich layered oxide has low initial Coulombic efficiency. A battery is activated while lithium is extracted from Li₂MnO₃ by the first charging reaction, which takes place at a voltage level of 4.5 V or higher. As a result, the initial Coulombic efficiency is low. Second, lithium-rich layered oxide is structurally unstable, which is disadvantageous. The lithium extracted by charging fails to be intercalated reversibly upon discharging. For this reason, with repeated cycles, the positive electrode active material, a layered structure, transforms into a spinel phase. Lastly, the production of HF molecules, which are toxic, has been problematic. During cycling, the leaching of transition metals by side reactions between the active material and an electrolyte negatively affects battery life. To address the issues above, researchers are conducting studies focusing on approaches such as element doping, coating, and particle size control. Co-precipitation is being used primarily as the method of synthesizing such OLO materials. However, despite ongoing studies, the reasons for the improved capacity and poor life have not been fully explained in relation to currently available OLO materials. At the moment in need of further studies, there has been a report regarding a cooling method of nickel-cobalt-aluminum (NCA) positive electrode materials. While a rapid cooling method by taking tubes out of a furnace and dipping the tubes in water has been proposed, this method affects the interlayer distance, which has an impact on the intercalation and deintercalation of lithium, and the composition of Ni³⁺ was confirmed to be decreased. To meet the demand for advanced properties, changes in the cooling method, which refers to a post-treatment process after sintering, have been made even in the OLO synthesis method to understand the impact of such a method.

In the present disclosure, an OLO material has been prepared in a form involving a sol-gel method, which is advantageous in the formation of nanoparticles, rather than co-precipitation among various methods. In addition, the present disclosure aims to enable particle size control through a simple change in the post-treatment process, identify characteristics of the OLO material in a positive batteries, electrode for secondary and propose the applicability of the OLO material as a positive electrode for next-generation high-capacity lithium-ion batteries.

### SUMMARY

The present disclosure aims to provide a positive electrode active material capable of improving the capacity of an electrochemical device through control over sintering temperature during a process of preparing the positive electrode active material to control the structure thereof, a method of preparing the same, and an electrochemical device including the same.

However, the problems to be solved by the present disclosure are not limited to the aforementioned description, and other problems can be clearly understood by those skilled in the art from the following description.

One embodiment of the present disclosure provides a method of preparing a positive electrode active material, which includes the following steps: S10 of thermally treating a precursor for a positive electrode active material; S30 of subjecting the thermally treated precursor for the positive electrode active material to primary sintering and secondary sintering; and S50 of rapidly cooling the sintered precursor for the positive electrode active material.

According to one embodiment of the present disclosure, the secondary sintering may be to thermally treat the primarily sintered precursor to a temperature of 750° C. or higher and 850° C. or lower.

According to one embodiment of the present disclosure, Step S50 of rapidly cooling may be to cool the sintered precursor for the positive electrode active material using liquid nitrogen.

According to one embodiment of the present disclosure, the precursor for the positive electrode active material may be in a sol-gel state.

According to one embodiment of the present disclosure, Step S5 of preparing the precursor for the positive electrode active material, the precursor including a raw material, may be further included before Step S10 of thermally treating.

According to one embodiment of the present disclosure, Step S5 of preparing the precursor for the positive electrode active material may be to cause a mixture in which the raw material and a solvent are mixed to react.

According to one embodiment of the present disclosure, the solvent may be deionized water, acetic acid, or a combination thereof.

According to one embodiment of the present disclosure, the raw material may include one or more selected from a Li-based compound, a Ni-based compound, a Mn-based compound, a Co-based compound, an Al-based compound, a Mg-based compound, a Cu-based compound, a Zn-based compound, a Ga-based compound, an Sb-based compound, a Sn-based compound, an As-based compound, and a combination thereof.

According to one embodiment of the present disclosure, Step S5 of preparing the precursor for the positive electrode active material may be to cause the raw material to react at a temperature of 50° C. or higher and 100° C. or lower for 5 hours or more and 15 hours or less.

According to one embodiment of the present disclosure, Step S10 of thermally treating may be to heat the precursor to a temperature of 300° C. or higher and 500° C. or lower.

According to one embodiment of the present disclosure, a secondary sintering temperature may be higher than a primary sintering temperature.

According to one embodiment of the present disclosure, the primary sintering may be to heat the thermally treated precursor to a temperature of 400° C. or higher and 600° C. or lower for 300 minutes or more and 500 minutes or less.

According to one embodiment of the present disclosure, the secondary sintering may be to heat the primarily sintered precursor for 400 minutes or more and 800 minutes or less.

According to one embodiment of the present disclosure, Step S20 of annealing the thermally treated precursor for the positive electrode active material to a temperature of 50° C. or higher and 100° C. or lower for 6 hours or more and 18 hours or less may be further included after Step S10 of thermally treating the precursor for the positive electrode active material.

One embodiment of the present disclosure provides a positive electrode active material prepared by the above method.

One embodiment of the present disclosure provides an electrochemical device including: a positive electrode including the above positive electrode active material; a negative electrode; and a separator to be interposed between the positive and negative electrodes.

A method of preparing a positive electrode active material, according to one embodiment f the present disclosure, can control the particle size of the positive electrode active material through simple post-treatment and improve the specific capacity of an electrochemical device.

A positive electrode active material, according to one embodiment of the present disclosure, can improve the specific capacity of an electrochemical device and thus maximize the performance thereof.

An electrochemical device, according to one embodiment of the present disclosure, can have improved specific capacity and thus have improved life.

### BRIEF DESCRIPTION OF THE DRAWINGS

FIG. 1 is a flowchart illustrating a method of preparing a positive electrode active material, according to one embodiment of the present disclosure;

FIG. 2 is a schematic diagram illustrating an electrochemical device according to one embodiment of the present disclosure;

FIG. 3 is a diagram showing sintering temperatures and times in Examples 1 and 2 and Comparative Examples 1 and 2, as a graph;

FIG. 4 is a diagram showing X-ray diffraction (XRD) peaks in Examples 1 and 2 and Comparative Examples 1 and 2; and

FIG. 5 is a graph showing specific capacities of cells based on Examples 1 and 2 and Comparative Examples 1 and 2, as a function of the number of charge and discharge cycles.

### DETAILED DESCRIPTION

As used herein, when one part is referred to as “comprising” or “including” one constituent element, this means that another constituent element may be further included, but does not preclude the presence thereof unless the context clearly indicates otherwise.

As used herein, “A and/or B” refers to “A and B, or A or B”.

The drawings attached hereto, which are illustrative of a preferred embodiment of the present disclosure, are provided to describe the principles of the present disclosure in conjunction with the description of the present disclosure, and the scope of the present disclosure is not limited thereto. In the meantime, the forms, sizes, scales, proportions, or the like of elements in the drawings herein may be exaggerated to emphasize a clearer description.

Hereinafter, the present disclosure will be described in more detail.

One embodiment of the present disclosure provides a method of preparing a positive electrode active material, which includes the following steps: S10 of thermally treating a precursor for a positive electrode active material; S30 of subjecting the thermally treated precursor for the positive electrode active material to primary sintering and secondary sintering; and S50 of rapidly cooling the sintered precursor for the positive electrode active material.

The method of preparing the positive electrode active material, according to one embodiment of the present disclosure, can control the particle size of the positive electrode active material through simple post-treatment and improve the specific capacity of an electrochemical device.

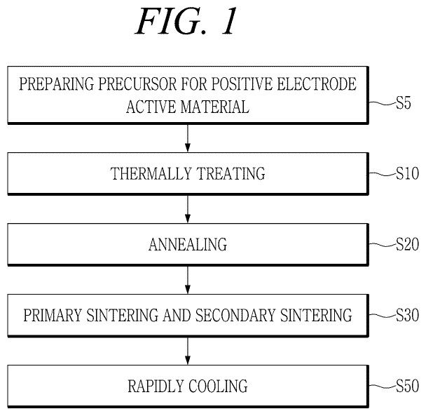

FIG. 1 is a flowchart illustrating the method of preparing the positive electrode active material, according to one embodiment of the present disclosure.

According to one embodiment of the present disclosure, the method of preparing the positive electrode active material includes Step S10 of thermally treating the precursor for the positive electrode active material. The method of preparing the positive electrode active material includes Step S10 of thermally treating the precursor for the positive electrode active material, as described above, thus enabling the basic structure of the precursor for the positive electrode active material to be determined.

According to one embodiment of the present disclosure, the method of preparing the positive electrode active material includes Step S30 of subjecting the thermally treated precursor for the positive electrode active material to the primary sintering and the secondary sintering. The method of preparing the positive electrode active material includes Step S30 of subjecting the thermally treated precursor for the positive electrode active material to the primary sintering and the secondary sintering, as described above, thus enabling control over the particle size of the positive electrode active material and the ionic state present on the surface thereof.

According to one embodiment of the present disclosure, Step S30 of the primary sintering and the secondary sintering may be to subject the precursor for the positive electrode active material to the primary sintering and then the secondary sintering. The precursor for the positive electrode active material is subjected to the primary sintering and then the secondary sintering in Step S30 of the primary sintering and the secondary sintering, as described above, thus enabling control over the particle size of the precursor for the positive electrode active material and the ionic state present on the surface thereof.

According to one embodiment of the present disclosure, a heating rate to heat the precursor to a primary sintering temperature may be 1.0° C./min or more and 2.0° C./min or less. Specifically, the heating rate to heat the precursor to the primary sintering temperature may be 1.5° C./min or more and 1.9° C./min or less. The heating rate to heat the precursor to the primary sintering temperature is controlled within the aforementioned range, thus enabling control over the particle size of the precursor for the positive electrode active material and the ionic state present on the surface thereof.

According to one embodiment of the present disclosure, a heating rate to heat the precursor to a secondary sintering temperature from the primary sintering temperature may be 1.0° C./min or more and 1.5° C./min or less. Specifically, the heating rate to heat the precursor to the secondary sintering temperature from the primary sintering temperature may be 1.05° C./min or more and 1.20° C./min or less. The heating rate to heat the precursor to the secondary sintering temperature from the primary sintering temperature is controlled within the aforementioned range, thus enabling control over the particle size of the precursor for the positive electrode active material and the ionic state present on the surface thereof.

According to one embodiment of the present disclosure, the method of preparing the positive electrode active material includes Step S50 of rapidly cooling the sintered precursor for the positive electrode active material. Specifically, the rapid cooling may refer to quenching. The method of preparing the positive electrode active material includes Step S50 of rapidly cooling the sintered precursor for the positive electrode active material, as described above, thus enabling control over the particle size of the precursor for the positive electrode active material and the ionic state present on the surface thereof.

According to one embodiment of the present disclosure, a rapid cooling rate may be −2,000° C./min or more and −500° C./min or less. The rapid cooling rate may be controlled within the aforementioned range, thus enabling control over the particle size of the precursor for the positive electrode active material and the ionic state present on the surface thereof.

According to one embodiment of the present disclosure, the secondary sintering may be to thermally treat the primarily sintered precursor to a temperature of 750° C. or higher and 850° C. or lower. The secondary sintering temperature may be controlled within the aforementioned range, thus improving the specific capacity of an electrochemical device and enabling control over the particle size of the precursor for the positive electrode active material and the ionic state present on the surface thereof.

According to one embodiment of the present disclosure, Step S50 of rapidly cooling may be to cool the sintered precursor for the positive electrode active material using liquid nitrogen. The rapid cooling step may be implemented as a process of cooling the precursor using liquid nitrogen, as described above, thus enabling control over the particle size of the precursor for the positive electrode active material and the ionic state present on the surface thereof.

According to one embodiment of the present disclosure, the precursor for the positive electrode active material may be in a sol-gel state. Those in a sol-gel state may be selected as the precursor for the positive electrode active material, as described above, thus improving the ease of electrode preparing the positive active material and facilitating the preparation of a desired form. As used herein, the sol may refer to a colloidal state in which solid particles are dispersed in a liquid, and the gel may refer to a semi-solid state formed by the liquid content decreased compared to that in the sol. As used herein, the sol-gel state may refer to any state occurring during the sol-to-gel transition.

According to one embodiment of the present disclosure, Step S5 of preparing the precursor for the positive electrode active material, the precursor including a raw material, may be further included before Step S10 of thermally treating. Specifically, the precursor for the positive electrode active material may refer to the raw material itself or a mixture in which the raw material and a solvent are mixed. Step S5 of preparing the precursor for the positive electrode active material, the precursor including the raw material, may be further included before Step S10 of thermally treating, as described above, thus enabling control over the component ratio of the positive electrode active material.

According to one embodiment of the present disclosure, Step S5 of preparing the precursor for the positive electrode active material may be to cause the mixture in which the raw material and the solvent are mixed to react. Specifically, Step S5 of preparing the precursor for the positive electrode active material may be to cause the mixture in which the raw material and the solvent are mixed to react by heating. In addition, a sol-gel form may be formed by causing the mixture in which the raw material and the solvent are mixed to react by heating. The mixture in which the raw material and the solvent are mixed may be allowed to react in Step S5 of preparing the precursor for the positive electrode active material, as described above, thus improving the uniformity of the precursor for the positive electrode active material and reducing the preparation time.

According to one embodiment of the present disclosure, the solvent may be deionized water, acetic acid, or a combination thereof. Those described above may be selected as the solvent, thus facilitating the solvent to evaporate, protecting the precursor for the positive electrode active material from being denatured by the solvent, and forming the precursor for the positive electrode active material in the sol-gel form.

According to one embodiment of the present disclosure, the raw material may include one or more selected from a Li-based compound, a Ni-based compound, a Mn-based compound, a Co-based compound, an Al-based compound, a Mg-based compound, a Cu-based compound, a Zn-based compound, a Ga-based compound, a Sn-based compound, an As-based an Sb-based compound, compound, and a combination thereof. Specifically, the raw material may include one or more selected from a Li-based compound, a Ni-based compound, a Mn-based compound, a Co-based compound, and a combination thereof. As used herein, an M-based compound may refer to a salt or compound containing M metal as cations. Furthermore, anions binding to the cations of M-based compound are usable without limitations as long as the cations of M metal are capable of bonding to anions.

The raw material may be selected from those described above, thus improving the specific capacity of an electrochemical device.

According to one embodiment of the present disclosure, Step S5 of preparing the precursor for the positive electrode active material may be to cause the raw material to react at a temperature of 50° C. or higher and 100° C. or lower for 5 hours or more and 15 hours or less. In other words, Step S5 of preparing the precursor for the positive electrode active material may be to heat the raw material at a temperature of 50° C. or higher and 100° C. or lower for 5 hours or more and 15 hours or less. Specifically, Step S5 of preparing the precursor for the positive electrode active material may be to cause the raw material to react at a temperature of 80° C. or higher and 100° C. or lower for 8 hours or more and 10 hours or less. The reaction temperature and time of the raw material may be controlled in Step S5 of preparing the precursor for the positive electrode active material, as described above, thus enabling control over the particle size of the precursor for the positive electrode active material and the ionic state present on the surface thereof.

According to one embodiment of the present disclosure, Step S10 of thermally treating may be to heat the precursor to a temperature of 300° C. or higher and 500° C. or lower. Specifically, Step S10 of thermally treating may be to heat the precursor to a temperature of 350° C. or higher and 450° C. or lower. The temperature in Step S10 of thermally treating may be controlled within the aforementioned range, thus enabling control over the particle size of the precursor for the positive electrode active material and the ionic state present on the surface thereof.

According to one embodiment of the present disclosure, the secondary sintering temperature may be higher than a primary sintering temperature. The secondary sintering temperature may be implemented as being higher than the primary sintering temperature, as described above, thus enabling control over the particle size of the precursor for the positive electrode active material and the ionic state present on the surface thereof.

According to one embodiment of the present disclosure, the primary sintering may be to heat the thermally treated precursor to a temperature of 400° C. or higher and 600° C. or lower for 300 minutes or more and 500 minutes or less. Specifically, the primary sintering may be to heat the thermally treated precursor to a temperature of 450° C. or higher and 550° C. or lower for 350 minutes or more and 450 minutes or less. The temperature and time of the primary sintering may be controlled within the aforementioned range, thus enabling control over the particle size of the precursor for the positive electrode active material and the ionic state present on the surface thereof.

According to one embodiment of the present disclosure, the secondary sintering may be to heat the primarily sintered precursor for 400 minutes or more and 800 minutes or less. Specifically, the secondary sintering may be to heat the primarily sintered precursor for 500 minutes or more and 700 minutes or less. The secondary sintering time may be controlled within the aforementioned range, thus enabling control over the particle size of the precursor for the positive electrode active material and the ionic state present on the surface thereof.

According to one embodiment of the present disclosure, Step S20 of annealing the thermally treated precursor for the positive electrode active material to a temperature of 50° C. or higher and 100° C. or lower for 6 hours or more and 18 hours or less may be further included after Step S10 of thermally treating the precursor for the positive electrode active material. In other words, the annealing step may refer to slowly cooling the thermally treated precursor for the positive electrode active material at the temperature above. Specifically, Step S20 of annealing the thermally treated precursor for the positive electrode active material to a temperature of 70° C. or higher and 90° C. or lower for 10 hours or more and 14 hours or less may be further included after Step S10 of thermally treating the precursor for the positive electrode active material, thus enabling control over the particle size of the precursor for the positive electrode active material and the ionic state present on the surface thereof.

One embodiment of the present disclosure provides a positive electrode active material prepared by the above method.

The positive electrode active material, according to one embodiment of the present disclosure, can improve the specific capacity of an electrochemical device and thus maximize the performance thereof.

One embodiment of the present disclosure provides a positive electrode 10 including the above positive electrode active material.

According to one embodiment of the present disclosure, the positive electrode 10 may include a positive electrode current collector and a positive electrode active material layer formed on the positive electrode current collector, and the positive electrode active material layer may include the above positive electrode active material.

According to one embodiment of the present disclosure, the positive electrode current collector may include a highly conductive metal. Any positive electrode current collectors that are not reactive within a voltage level range of batteries and to which the positive electrode active material layer easily adheres are usable without particular limitations. Specifically, examples of the positive electrode current collector used may include stainless steel, aluminum, nickel, titanium, calcined carbon, aluminum or stainless steel whose surface is treated with carbon, nickel, titanium, silver, or the like, and the like.

According to one embodiment of the present disclosure, the positive electrode current collector may typically have a thickness in the range of 3 μm to 500 μm.

According to one embodiment of the present disclosure, the adhesive strength of the positive electrode active material may be increased through the formation of fine protrusions and depressions on the surface of the positive electrode current collector. Specifically, the positive electrode current collector used may have various forms, such as a film, a sheet, a foil, a net, a porous body, a foam, or a non-woven body.

According to one embodiment of the present disclosure, the positive electrode active material layer may optionally include a conductive additive and/or a binder, in conjunction with the above positive electrode active material.

According to one embodiment of the present disclosure, the positive electrode active material may be contained in an amount range of 80 wt % to 99 wt %, specifically in the range of 85 wt % to 98.5 wt %, with respect to the total weight of the positive electrode active material layer. The amount of the positive electrode active material contained may be controlled within the aforementioned range, thus enabling excellent capacity characteristics of an electrochemical device to be exhibited.

According to one embodiment of the present disclosure, the conductive additive is used to impart conductivity to electrodes, and any conductive additives that are electronically conductive while not causing chemical changes are usable without particular limitations in a battery to be formed. Specifically, examples of the conductive additive may include: graphite, such as natural graphite or synthetic graphite; carbon-based materials, such as carbon black, acetylene black, Ketjen black, channel black, furnace black, lamp black, thermal black, or carbon fibers; metal powders or metal fibers, such as copper, nickel, aluminum, or silver; conductive tubes, such as carbon nanotubes; conductive whiskers, such as zinc oxide or potassium titanate; conductive metal oxides, such as titanium oxide; conductive polymers, such as polyphenylene derivatives; and the like, among which one type alone or a mixture of two or more types may be used.

According to one embodiment of the present disclosure, the conductive additive may be contained in an amount range of 0.1 wt % to 15 wt % with respect to the total weight of the positive electrode active material layer.

According to one embodiment of the present disclosure, the binder serves to improve the adhesion between the positive electrode active material particles and the adhesive strength of the positive electrode active material to the current collector. Specifically, examples of the binder may include polyvinylidene fluoride (PVDF), polyvinylidene fluoride-co-hexafluoropropylene copolymers (PVDF-co-HFP), polyvinyl alcohol, polyacrylonitrile, polymethyl methacrylate, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene polymers (EPDM), sulfonated-EPDM, styrene-butadiene rubber (SBR), fluoroelastomers, polyacrylic acid, polymers thereof in which hydrogen is replaced with Li, Na, or Ca, various copolymers thereof, and the like, among which one type alone or a mixture of two or more types may be used.

According to one embodiment of the present disclosure, the binder may be contained in an amount range of 0.1 wt % to wt % with respect to the total weight of the positive electrode active material layer.

According to one embodiment of the present disclosure, the positive electrode 10 may be manufactured by common methods of manufacturing positive electrodes, except for using the above positive electrode active material. Specifically, the positive electrode 10 may be manufactured by applying a composition for forming the positive electrode active material layer, the composition prepared by dissolving or dispersing the positive electrode active material and, optionally, the binder, the conductive additive, and/or a dispersant in a solvent, on the positive electrode current collector, followed by drying and rolling. Alternatively, the positive electrode 10 may be manufactured by casting the above composition for forming the positive electrode active material layer on a separate support and then laminating the obtained film detached from the support on the positive electrode current collector.

According to one embodiment of the present disclosure, the solvent may be any solvent commonly used in the art, and examples thereof may include dimethyl sulfoxide (DMSO), isopropyl alcohol, N-methylpyrrolidone (NMP), dimethylformamide (DMF), acetone, water, and the like, among which one type alone or a mixture of two or more types may be used.

According to one embodiment of the present disclosure, the amount of the solvent used is sufficient as long as the amount allows a viscosity capable of exhibiting excellent subsequent application thickness uniformity during to manufacture the positive electrode as well as enabling the positive electrode active material, the conductive additive, the binder, and the dispersant to be dissolved or dispersed, taking into account the application thickness and yield of a slurry made of the composition for forming the positive electrode active material layer.

One embodiment of the present disclosure provides an electrochemical device 100 including: a positive electrode 10 including the above positive electrode active material; a negative electrode 30; and a separator 50 to be interposed between the positive electrode 10 and the negative electrode 30.

The electrochemical device 100, according to one improved embodiment of the present disclosure, can have specific capacity and thus have improved life.

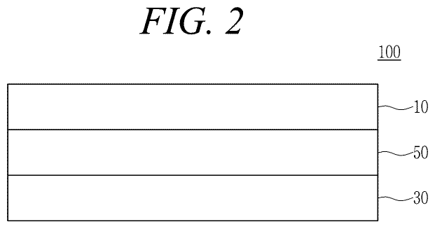

FIG. 2 is a schematic diagram illustrating the electrochemical device according to one embodiment of the present disclosure. Referring to FIG. 2, the electrochemical element 100, which is one embodiment of the present disclosure, will be described in detail.

According to one embodiment of the present disclosure, the electrochemical device 100 may further optionally include: a cell casing configured to house the electrode assembly of the positive electrode 10, the negative electrode 30, and the separator 50; and a sealing member configured to seal the cell casing.

According to one embodiment of the present disclosure, the electrochemical device 100 may further include an electrolyte.

According to one embodiment of the present disclosure, the negative electrode 30 may include a negative electrode current collector and a negative electrode active material layer positioned on the negative electrode current collector.

According to one embodiment of the present disclosure, any negative electrode current collectors that are highly conductive while not causing chemical changes in batteries may are usable without particular limitations. Specifically, examples of the negative electrode current collector used may include copper, stainless steel, aluminum, nickel, titanium, calcined carbon, copper or stainless steel whose surface is treated with carbon, nickel, titanium, silver, or the like, aluminum-cadmium alloys, and the like.

According to one embodiment of the present disclosure, the negative electrode current collector may typically have a thickness in the range of 3 μm to 500 μm.

According to one embodiment of the present disclosure, the bonding strength of a negative electrode active material may be strengthened through the formation of fine protrusions and depressions on the surface of the negative electrode current collector. Specifically, the negative electrode current collector used may have various forms, such as a film, a sheet, a foil, a net, a porous body, a foam, or a non-woven body.

According to one embodiment of the present disclosure, the negative electrode active material layer may optionally include a binder and a conductive additive, in conjunction with the negative electrode active material.

According to one embodiment of the present disclosure, any compounds capable of reversible intercalation and deintercalation of lithium are usable as the negative electrode active material. Specifically, examples of the negative electrode active material may include: carbonaceous materials, such as synthetic graphite, natural graphite, graphitized carbon fibers, or amorphous carbon; metallic compounds capable of forming an alloy with lithium, such as Si, Al, Sn, Pb, Zn, Bi, In, Mg, Ga, Cd, Si alloys, Sn alloys, or Al alloys; metal oxides capable of doping and undoping lithium, such as SiO_{β} (where 0<β<2), SnO₂, vanadium oxide, or lithium vanadium oxide; composites including the metallic compound and the carbonaceous material described above, such as Sn—C composites or Sn—C composites; and the like, among which any one or a mixture of two or more may be used. In addition, a lithium metal thin film may be used as the negative electrode active material. Furthermore, the carbonaceous materials used may include both low-crystalline carbon and high-crystalline carbon. Representative examples of low-crystalline carbon include soft carbon and hard carbon, while representative examples of high-crystalline carbon include amorphous, layered, flake, spherical, or fibrous natural or synthetic graphite, Kish graphite, pyrolytic carbon, mesophase pitch-based carbon fibers, mesocarbon microbeads, mesophase pitches, and high-temperature calcined carbon, such as petroleum or coal tar pitch-derived cokes.

According to one embodiment of the present disclosure, the negative electrode active material may be contained in an amount range of 80 wt % to 99 wt % with respect to the total weight of the negative electrode active material layer.

According to one embodiment of the present disclosure, the binder in the negative electrode active material layer, which is configured to assist in the binding between the conductive additive, the active material, and the current collector, may typically be added in an amount range of 0.1 wt % to 10 wt % with respect to the total weight of the negative electrode active material layer. Specifically, examples of the binder in the negative electrode active material layer may include PVDF, polyvinyl alcohol, CMC, starch, hydroxypropyl cellulose, regenerated cellulose, polyvinylpyrrolidone, polytetrafluoroethylene, polyethylene, polypropylene, EPDM, sulfonated-EPDM, SBR, nitrile-butadiene rubber, fluoroelastomers, various copolymers thereof, and the like.

According to one embodiment of the present disclosure, the conductive additive in the negative electrode active material layer, which is configured to further improve the conductivity of the negative electrode active material, may be added in an amount range of 10 wt % or less, preferably 5 wt % or less, with respect to the total weight of the negative electrode active material layer.

According to one embodiment of the present disclosure, any conductive additives that are conductive while not causing chemical changes in batteries in the art are usable without particular limitations as the conductive additive in the negative electrode active material layer. Specifically, examples of the conductive additive used in the negative electrode active material layer may include: graphite, such as natural graphite or synthetic graphite; carbon black, such as acetylene black, Ketjen black, channel black, furnace black, lamp black, or thermal black; conductive fibers, such as carbon fibers or metal fibers; fluorocarbons; metal powders, such as aluminum and nickel powers; conductive whiskers, such as zinc oxide or potassium titanate; conductive metal oxides, such as titanium oxide; conductive materials, such as polyphenylene derivatives; and the like.

According to one embodiment of the present disclosure, the negative electrode 30 may be manufactured by applying a composition for forming the negative electrode active material layer, the composition prepared by dissolving or dispersing the negative electrode active material and, optionally, the binder and the conductive additive in a solvent, on the negative electrode current collector, followed by drying. Alternatively, the negative electrode 30 may be manufactured by casting the above composition for forming the negative electrode active material layer on a separate support and then laminating the obtained film detached from the support on the negative electrode current collector.

According to one embodiment of the present disclosure, the separator 50 is configured to separate the negative electrode 30 from the positive electrode 10 and provide a passage for lithium ions to migrate. Any separators commonly used in lithium secondary batteries are usable without particular limitations. In particular, those having a low resistance to ion migration in the electrolyte and excellent electrolyte impregnation ability are preferable.

According to one embodiment of the present disclosure, as the separator 50, a porous polymer film, which is, for example, formed using polyolefin-based polymers, such as ethylene homopolymers, propylene homopolymers, ethylene/butene copolymers, ethylene/hexene copolymers, and ethylene/methacrylate copolymers, or a structure in which two or more layers thereof are laminated may be used. In addition, common porous non-woven fabrics, for example, non-woven fabrics made of polyethylene terephthalate fibers, glass fibers having high melting points, and the like, may be used.

According to one embodiment of the present disclosure, a coated separator in which ceramic components and/or polymeric materials are included may be used as the separator 50 to ensure heat resistance or mechanical strength. In addition, the separator 50 used may optionally have a single-layer or multilayer structure.

In one embodiment of the present disclosure, examples of the electrolyte may include organic liquid electrolytes, inorganic liquid electrolytes, solid polymer electrolytes, gel-type polymer electrolytes, solid inorganic electrolytes, molten inorganic electrolytes, and the like, which are usable when manufacturing lithium secondary batteries, but the electrolyte is not limited thereto. Specifically, the electrolyte may include an organic solvent and a lithium salt.

According to one embodiment of the present disclosure, any solvents capable of serving as a medium through which ions involved in the electrochemical reactions of batteries can migrate are usable as the inorganic solvent without particular limitations. Specifically, examples of the organic solvent used may include: ester-based solvents, such as methyl acetate, ethyl acetate, γ-butyrolactone, or ε-caprolactone; ether-based solvents, such as dibutyl ether or tetrahydrofuran; ketone-based solvents, such as cyclohexanone; aromatic hydrocarbon-based solvents, such as benzene or fluorobenzene; carbonate-based solvents, such as dimethyl carbonate (DMC), diethyl carbonate (DEC), methyl ethyl carbonate (MEC), ethyl methyl carbonate (EMC), ethylene carbonate (EC), or propylene carbonate (PC); alcohol-based solvents, such as ethyl alcohol or isopropyl alcohol; nitriles, such as R—CN (where R is a straight-chain, branched-chain, or cyclic hydrocarbon group having 2 to 20 carbon atoms, which may contain a double-bond aromatic ring or an ether bond); amides, such as DMF; dioxolanes, such as 1,3-dioxolane; sulfolanes; and the like. Of all these, carbonate-based solvents are preferable, and mixtures of cyclic carbonates (for example, ethylene carbonate, propylene carbonate, or the like) having high ionic conductivity and high dielectric constant, which are capable of improving the charge and discharge performance of batteries, and straight-chain carbonate-based compounds (for example, ethyl methyl carbonate, dimethyl carbonate, diethyl carbonate, or the like) having low viscosity are more preferable.

According to one embodiment of the present disclosure, any compounds capable of providing lithium ions used in lithium secondary batteries are usable as the lithium salt without particular limitations. Specifically, the anion of the lithium salt may be at least one selected from the group consisting of F⁻, Cl⁻, Br⁻, I⁻, NO₃⁻, N(CN)₂⁻, BF₄⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₃N⁻. In addition, examples of the lithium salt used may include LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, LiB(C₂O₄)₂, and the like.

According to one embodiment of the present disclosure, it is preferable that the lithium salt used has a concentration in the range of 0.1 M to 2.0 M. The electrolyte is allowed to have suitable conductivity and viscosity through control over the concentration of the lithium salt within the aforementioned range, thus enabling excellent electrolyte performance to be exhibited and lithium ions to migrate effectively.

According to one embodiment of the present disclosure, the electrolyte may further include one or more types of additives, for example, pyridine, triethyl phosphite, triethanolamine, cyclic ether, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride, halo-alkylene carbonate-based compounds such as difluoroethylene carbonate, and the like, in addition to the constituent elements described above, for the purposes of improving life characteristics of batteries, suppressing the reduction in battery capacity, and improving discharge capacity of batteries.

According to one embodiment of the present disclosure, the additive may be contained in an amount range of 0.1 wt % to 5 wt % with respect to the total weight of the electrolyte.

According to one embodiment of the present disclosure, the electrochemical device, including the positive electrode active material, stably exhibits excellent capacity characteristics, output characteristics, and life characteristics and, therefore, is useful in the fields of portable devices such as cell phones, laptops, and digital cameras, electric vehicles (EVs) such as hybrid electric vehicles (HEVs), and the like.

According to one embodiment of the present disclosure, the electrochemical device may be a lithium secondary battery.

According to one embodiment of the present disclosure, there are no particular limitations in the appearance of the electrochemical device, that is, the lithium secondary battery, but the appearance may be cylindrical using a can, prismatic, pouch-type, or coin-type.

According to one embodiment of the present disclosure, the lithium secondary battery is preferably usable not only as a battery cell used as a power source for small devices but also as a unit cell in a medium to large battery module including a plurality of battery cells.

Therefore, according to one embodiment of the present disclosure, provided are a battery module including the lithium secondary battery as a unit cell and a battery pack including the same.

According to one embodiment of the present disclosure, the battery module or the battery pack may be used as a power source for one or more of the following medium to large devices: power tools; EVs, including HEVs and plug-in HEVs (PHEV); or power storage systems.

Hereinafter, the present disclosure will be described in detail through examples. However, the examples according to the present disclosure may be modified in many different forms, and the scope of the present specification is not construed as being limited to the examples described below. The examples herein are provided to fully explain the present disclosure to those skilled in the art to which the present disclosure pertains.

### Example 1

Li-based compounds, 4.85 g of lithium nitrate [LiNO₃ (Aldrich, 99%)] and 7.177 g of lithium acetate dihydrate [CH₃COLi·2H₂O (Aldrich, 98%)], a Ni-based compound, 4.432 g of nickel (II) nitrate hexahydrate [Ni(NO₃)₂·6H₂O (Aldrich, 99.99%)], a Mn-based compound, 15.518 g of manganese acetate tetrahydrate [Mn(CH₃CO₂)₂·4H₂O (Aldrich, +99%)], and a Co-based compound, 4.436 g of positive cobalt (II) nitrate hexahydrate [Co(NO₃)₂·6H₂O (Aldrich, 98%)], were added to a solvent in which deionized water and acetic acid were mixed in a 3:1 weight ratio. Then, the resulting mixture was allowed to react at a temperature of 90° C. for 9 hours to prepare a precursor in a sol-gel form for a positive electrode active material.

The precursor in the sol-gel form for the positive electrode active material, prepared above, was subjected to combustion synthesis at a temperature of 400° C.

The thermally treated precursor for the positive electrode active material was then annealed at a temperature of 80° C. for 12 hours. Next, the annealed precursor for the positive electrode active material was subjected to primary sintering at a temperature of 400° C. for about 320 minutes and then secondary sintering at a temperature of 900° C. for about 450 minutes.

The sintered precursor for the positive electrode active material was rapidly cooled using liquid nitrogen, thereby preparing the positive electrode active material.

### Example 2

A positive electrode active material was prepared in the same manner as in Example 1 above, except for performing the secondary sintering at a temperature of 800° C. for about 550 minutes.

### Comparative Example 1

A positive electrode active material was prepared in the same manner as in Example 1 above, except for involving cooling at room temperature (natural cooling) instead of rapid cooling using liquid nitrogen.

### Comparative Example 2

A positive electrode active material was prepared in the same manner as in Example 1 above, except for involving cooling at room temperature (natural cooling) instead of rapid cooling using liquid nitrogen while performing the secondary sintering at a temperature of 800° C. for about 550 minutes.

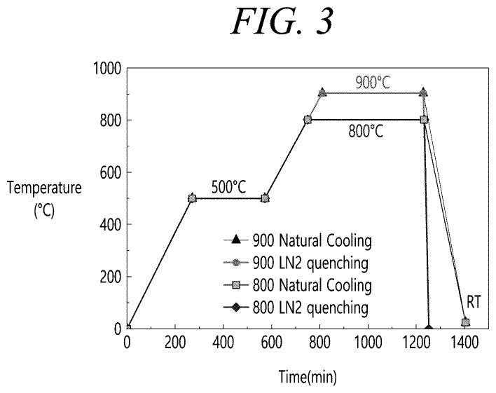

FIG. 3 is a diagram showing sintering temperatures and times in Examples 1 and 2 and Comparative Examples 1 and 2, as a graph. As shown in FIG. 3, the positive electrode active materials were prepared by varying the sintering time, the sintering temperature, and the cooling time of the same precursor for the positive electrode active material. In FIG. 3 mentioned above, “900 LN2 quenching” refers to Example 1, “800 LN2 quenching” refers to Example 2, “900 Natural Cooling” refers to Comparative Example 1, and “800 Natural Cooling” refers to Comparative Example 2. In FIG. 3 mentioned above, “RT” stands for room temperature.

### Experimental Example 1: XRD Peak Measurement

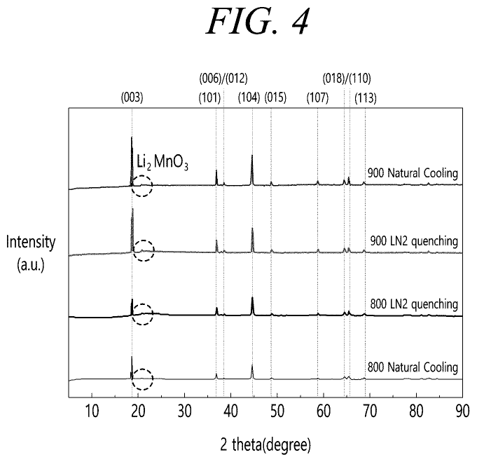

XRD measurement was performed on each of the positive electrode active materials prepared in the above examples and comparative examples. Each XRD data is shown in FIG. 4.

In this case, 2 g to 3 g of positive electrode active material particles were taken from each of the positive electrode active material powders prepared in the above examples and comparative examples for the XRD measurement by an XRD analysis method using Cu-Kα rays (at a wavelength of 1.54 Å) under the following conditions: an acceleration voltage of 40 kV/40 mA, a scan speed of 0.5°/sec, and a 2θ in the range of 5° to 90°.

FIG. 4 is a diagram showing XRD peaks in Examples 1 and 2 and Comparative Examples 1 and 2. In FIG. 4 mentioned above, “900 LN2 quenching” refers to Example 1, “800 LN2 quenching” refers to Example 2, “900 Natural Cooling” refers to Comparative Example 1, and “800 Natural Cooling” refers to Comparative Example 2.

Referring to FIG. 4, the XRD peaks confirmed the presence of a rhombohedral structure of the R3-m space group, and the Li₂MnO₃ peaks observed in a 2θ range of 19° to 23° confirmed the presence of a structure of the C2/m space group. As a result, it was confirmed that changes in the sintering temperature and the cooling method resulted in phase transition depending on each condition.

### Experimental Example 2: Specific Capacity Measurement of Cells as Function of Number of Charge and Discharge Cycles

A slurry for the positive electrode active material was prepared by mixing 80 wt % of each of the positive electrode active materials prepared in the above examples and comparative examples, 12 wt % of Super P serving as a conductive additive, and 8 wt % of PVDF serving as a binder, in NMP serving as a solvent. The slurry for the positive electrode active material, prepared above, was applied on one surface of a positive electrode current collector made of aluminum. Next, the resulting product was dried at a temperature of 130° C. for 12 hours and then rolled to manufacture a positive electrode.

While using a lithium metal electrode as a negative electrode, porous polyethylene serving as a separator was interposed between the positive and negative electrodes to manufacture an electrode assembly, which was then positioned inside a cell casing, followed by injecting an electrolyte in which 1 M of LiPF₆ was dissolved in an organic solvent in which EC and DMC were mixed in a 1:1 volume ratio. As a result, a coin-type half-cell was manufactured.

The coin-type half-cell, including each of the positive electrode active materials prepared in the above examples and comparative examples, was charged up to a voltage level of 4.8 V at a constant current of 0.1 C at a temperature of 25° C. and then discharged down to a voltage level of 2.0 V at a constant current of 0.1 C to measure the initial charge and discharge capacities.

Subsequently, a total of 50 cycles of charge and discharge were repeatedly performed to measure the specific capacities during charging and discharging.

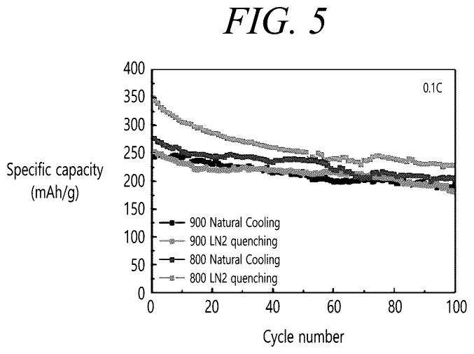

FIG. 5 is a graph showing the specific capacities of the cells based on Examples 1 and 2 and Comparative Examples 1 and 2, as a function of the number of charge and discharge cycles. In FIG. 5 mentioned above, “900 LN2 quenching” refers to Example 1, “800 LN2 quenching” refers to Example 2, “900 Natural Cooling” refers to Comparative Example 1, and “800 Natural Cooling” refers to Comparative Example 2.

Referring to FIG. 5, the first region of the graph, where a sloped curve is shown, is identified as a plateau observed due to transition metal ions oxidized to the 4⁺ state, like other layered oxides. In addition, the second region of the graph, where the slope decreases, at a voltage level of 4.5 V or higher is an oxygen loss stabilization phase, which was identified as a plateau observed due to Li₂MnO₃. The specific capacity of the cell based on Example 1 was confirmed to be improved by a value of 19 mAh/g compared to that of the cell based on Comparative Example 1. In addition, the specific capacity of the cell based on Comparative Example 2 was confirmed to be improved by a value of 67 mAh/g compared to that of the cell based on Example 2. Furthermore, the specific capacity of the cell based on Example 2, in which the secondary sintering temperature was 800° C., was improved by a value of 100 mAh/g compared to that of the cell based on Example 1, in which the secondary sintering temperature was 900° C.

### NATIONAL RESEARCH AND DEVELOPMENT PROJECT 1 SUPPORTED BY THE KOREAN GOVERNMENT ASSOCIATED WITH THIS DISCLOSURE

[Project Unique Number] 1711196575
[Project Serial Number] 23-KIER-1-1-5-1
[Government Department] Ministry of Science and ICT
[Specialized Institution for Project Management] Korea Institute of Energy Research
[Title of Research Business] Research Operation Funding from Korea Institute of Energy Research (Major Project Budget)
[Title of Project] Renewable Energy Research Institute Research Planning
[Supervising Institute] Korea Institute of Energy Research
[Research Period] Mar. 1, 2022 to Dec. 31, 2023

### NATIONAL RESEARCH AND DEVELOPMENT PROJECT 2 SUPPORTED BY THE KOREAN GOVERNMENT ASSOCIATED WITH THIS DISCLOSURE

[Project Serial Number] GTL24011-000
[Government Department] Ministry of Science and ICT
[Specialized Institution for Project Management] National Research Council of Science and Technology
[Title of Research Business] Global TOP Strategic Research Team Support Project
[Research Project Title] Ultra-Low-Cost ($50/kWh) and Long-Life Non-Lithium-Based Secondary Battery Development
[Supervising Institute] Korea Institute of Energy Research
[Research Period] Jun. 1, 2024 to May 31, 2029

What is claimed is:

1. A method of preparing a positive electrode active material, the method comprising:
thermally treating a precursor for a positive electrode active material;
subjecting the thermally treated precursor to primary sintering and secondary sintering; and
rapidly cooling the sintered precursor.

2. The method of claim 1, wherein the secondary sintering is to thermally treat the primarily sintered precursor to a temperature of 750° C. or higher and 850° C. or lower.

3. The method of claim 1, wherein the rapidly cooling is to cool the sintered precursor using liquid nitrogen.

4. The method of claim 1, wherein the precursor is in a sol-gel state.

5. The method of claim 1, further comprising:
before the thermally treating, preparing the precursor comprising a raw material.

6. The method of claim 5, wherein the preparing is to cause a mixture in which the raw material and a solvent are mixed to react.

7. The method of claim 6, wherein the solvent is deionized water, acetic acid, or a combination thereof.

8. The method of claim 5, wherein the raw material comprises one or more selected from a Li-based compound, a Ni-based compound, a Mn-based compound, a Co-based compound, an Al-based compound, a Mg-based compound, a Cu-based compound, a Zn-based compound, a Ga-based compound, an Sb-based compound, a Sn-based compound, an As-based compound, and a combination thereof.

9. The method of claim 5, wherein the preparing is to cause the raw material to react at a temperature of 50° C. or higher and 100° C. or lower for 5 hours or more and 15 hours or less.

10. The method of claim 1, wherein the thermally treating is to heat the precursor to a temperature of 300° C. or higher and 500° C. or lower.

11. The method of claim 1, wherein a secondary sintering temperature is higher than a primary sintering temperature.

12. The method of claim 1, wherein the primary sintering is to heat the thermally treated precursor to a temperature of 400° C. or higher and 600° C. or lower for 300 minutes or more and 500 minutes or less.

13. The method of claim 1, wherein the secondary sintering is to heat the primarily sintered precursor for 400 minutes or more and 800 minutes or less.

14. The method of claim 1, further comprising:
after the thermally treating, annealing the thermally treated precursor to a temperature of 50° C. or higher and 100° C. or lower for 6 hours or more and 18 hours or less.

15. A positive electrode active material prepared by the method of claim 1.

16. An electrochemical device comprising:
a positive electrode comprising the positive electrode active material of claim 15;
a negative electrode; and
a separator to be interposed between the positive and negative electrodes.
